(19) United States
(12) Patent Application Publication
(10) Pub. No.: US 2010/0283726 A1
(43) Pub. Date: Nov. 11, 2010

(54) USER INTERFACES AND ASSOCIATED APPARATUS AND METHODS

(75) Inventors: Mattias Andersson, Johanneshov (SE); Roni Burrell, Tel-Aviv (IL); Shunjiro Eguchi, Espoo (FI); Tom Jenkins, London (GB); Daniel Dhondt, Espoo (FI); Edwin Shannon, London (GB); Alejandro Sanguinetti, Helsinki (FI); Zachary Ng, North Point (HK); Lianne Mallett, London (GB); Nicola Ralston, London (GB); Manuel Gattinger, London (GB); Joeske Schellen, London (GB); Simon Dearsley, London (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/744,031

(22) PCT Filed: Nov. 20, 2007
(86) PCT No.: PCT/EP07/10033

§ 371 Date: Jul. 21, 2010

(51) Int. Cl. G06F 3/01

(52) U.S. Cl. 345/156

(57) ABSTRACT

Apparatus for a portable electronic device, the apparatus arranged to detect substantially simultaneous user input from device user interface elements arranged to detect opposing user input, and to provide signalling, upon the detection of said opposing user input, for transferring electronic information content associated with the electronic device to a remote apparatus which is associatable with the electronic device. Apparatus for a portable electronic device, the apparatus arranged to detect movement of the device, relative to a remote apparatus which is associatable with the electronic device, as user input from the device, and to provide signalling, upon the detection of said relative movement, for transferring electronic information content associated with the electronic device to the remote apparatus which is associatable with the electronic device.

### TECHNICAL FIELD

The present invention relates to the field of user interfaces for providing electronic information content and the transfer of electronic information content, associated methods, computer programs and apparatus.

Certain embodiments of the invention relate to portable electronic devices, in particular, so-called hand-portable electronic devices which may be hand-held in use (although they may be placed in a cradle in use). Such hand-portable electronic devices include so-called Personal Digital Assistants (PDAs). Portable electronic devices may also encompass comparatively simple memory cards/sticks etc. (such as so-called “USB memory sticks”), which are generally available to conveniently carry electronic information content. The portable electronic devices may also comprise a computer mouse.

The portable electronic devices of the present invention may provide one or more audio/text/video communication functions (e.g. telecommunication, videocommunication, and/or text transmission (Short Message Service (SMS)/Multimedia Message Service (MMS)/emailing) functions), interactive/non-interactive viewing functions (e.g. web-browsing, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Portable electronic devices are often used to carry electronic information content. which the user would want to transfer to other associatable electronic apparatus. For example, a user may wish to share or transfer electronic photos, electronically stored financial data, or some other form of electronically stored information content with/to another apparatus. Such transfers are initiated and conducted using a user interface, often a keypad.

The listing or discussion of a prior-published document or any background in this specification should not necessarily be taken as an acknowledgement that the document or background is part of the state of the art or is common general knowledge. One or more aspects/embodiments of the present invention may or may not address one or more of the background issues.

### SUMMARY

In a first aspect, there is provided an apparatus for a portable electronic device, the apparatus arranged to detect substantially simultaneous user input from device user interface elements arranged to detect opposing user input, and to provide signalling, upon the detection of said opposing user input, for transferring electronic information content associated with the electronic device to a remote apparatus which is associatable with the electronic device.

The apparatus may be arranged to detect the opposing user input from user input elements arranged to detect a squeeze, said squeeze providing an overall compression in one or more dimensions of the device.

The apparatus may be arranged to detect opposing user input by detecting input from a clasping hold of the device by one or more hands of a user.

The apparatus may be arranged to detect substantially simultaneous user input such that the user input from one element is shortly followed by user input from a second opposing element. The apparatus may be arranged to detect substantially simultaneous user input such that the user input from one element is shortly followed by user input from a second opposing element, said user input being considered a squeeze user input.

The apparatus may be arranged to detect substantially simultaneous user input such that the user input from the respective opposing device elements are essentially provided by the user at the same time. The apparatus may be arranged to detect substantially simultaneous user input such that the user input from the respective opposing device elements are essentially provided by the user at the same time, said user input being considered a squeeze user input.

The apparatus may be arranged to detect the opposing user input from user input elements arranged to detect respective user inputs physically towards one another. The apparatus may be arranged to detect the opposing user input from four user input elements arranged to detect respective user inputs physically towards one another.

The apparatus may be arranged to detect the opposing user input from user input elements arranged to detect respective user inputs physically towards a central longitudinal axis of the electronic device. The apparatus may be arranged to detect the opposing user input from user input elements arranged to detect respective user inputs physically towards an inner (e.g. central) point of the electronic device.

The apparatus may be arranged to detect the opposing user input from user input elements arranged to detect user input around a radial perimeter of the device.

The apparatus may be arranged to detect the opposing user input from user input elements arranged on two or more opposing faces of the device. The apparatus may be arranged to detect the opposing user input from user input elements arranged on four opposing faces of the device.

The apparatus may be arranged to detect the opposing user input from user input elements arranged on two opposing faces of the device and a third device face which extends substantially orthogonal to the two opposing faces.

The apparatus may be arranged to detect the opposing user input from three user input elements, two arranged to detect user input opposing one another and a third element arranged to detect user input from a plane orthogonal to the planes of the opposing user input elements. The apparatus may be arranged to detect the opposing user input from four user input elements, the first and second user input elements arranged to detect user input from planes opposing one another, the third and fourth elements arranged to detect user input from planes orthogonal to the planes of the first and second opposing user input elements.

The apparatus may be arranged to detect the opposing user input from three user input elements, two arranged on two opposing faces of the device to detect user input opposing one another, and a third element arranged on a face orthogonal to the opposing faces to detect user input from a plane orthogonal to the planes of the opposing user input elements. The apparatus may be arranged to detect the opposing user input from four user input elements, the first and second user input elements arranged to detect user input from device faces opposing one another, the third and fourth elements arranged to detect user input from device faces orthogonal to the device faces of the first and second opposing user input elements.

The apparatus may be arranged to detect user input from user input elements arranged integrally with the apparatus. The apparatus may be arranged to detect user input from user input elements arranged integrally with the device. The apparatus may be arranged to detect user input from user input elements associated with the device (e.g. user input elements on a computer mouse).

The apparatus may comprise the information content stored on integrated memory. The information content may be stored on memory on a separate device/apparatus and the apparatus may be arranged to initiate the transfer of information content from the memory of the separate device/apparatus to the remote apparatus.

The apparatus may be arranged such that the transferring of electronic information content is provided to a remote apparatus which is connected to the device by a physical external connection (e.g. USB connection or A/V plug) which allows repeatable connection of the device and the remote apparatus.

The apparatus may be arranged such that the transferring of electronic information content is provided to a remote apparatus which is connected to the device by an air interface connection which allows repeatable connection of the device and the remote apparatus. The air interface may be a short-range air interface (e.g. RFID, Bluetooth™ interface with a PDA, earpiece, video screen, computer mouse, memory stick/card), medium range interface (e.g. interface with a cellular base-station) and/or long range interface (e.g. interface with a satellite).

The apparatus may be arranged such that the signalling for transferring electronic information content initiates a connection with the remote apparatus which allows the transfer of information content to the remote apparatus. The apparatus may be arranged such that the signalling for transferring electronic information content actually transfers information content to the remote apparatus.

The portable electronic device may be a computer mouse associated with a desktop/laptop computer. The portable electronic device may be a memory card/stick.

The apparatus may be arranged such that the electronic information content comprises one or more pre-recorded content selected from the group comprising electronic files for providing navigation content, audio (e.g. pre-recorded music files, voice messages) content, image (e.g. captured/scanned still picture/video picture) content, messaging (e.g. emailing, MMS, SMS) content, text content (e.g. word processing), and content files generated using software packages (e.g. pdf files, drawing package (e.g. Powerpoint™) content, word processing content, spreadsheet content).

The apparatus may be arranged such that the electronic information content comprises one or more live content, generated during the associated of the remote apparatus with the device, selected from the group comprising providing navigation content, audio (e.g. music and/or speaking/voice) content, image (e.g. still picture/video picture) content, messaging (e.g. emailing, MMS, SMS) content, text content (e.g. word processing), content files generated using software packages (e.g. pdf files, drawing package (e.g. Powerpoint™) content, word processing content, spreadsheet content).

The apparatus may be arranged such that the detection of opposing input initiates/provides streaming of live content from the device to the remote apparatus.

The apparatus may be arranged to detect the user input following association of the device with the remote apparatus.

The user input elements may also be arranged to provide user output (e.g. a “touch-screen”).

The apparatus may comprise the user input elements. The apparatus may be a module for the portable electronic device.

In a second aspect, there is provided a portable electronic device comprising the aforementioned apparatus.

In a third aspect, there is provided a computer program for a portable electronic device, the computer program comprising computer code arranged to be used to detect, substantially simultaneous user input from device user interface elements arranged to detect opposing user input, and to provide signalling, upon the detection of said opposing user input, for transferring electronic information content associated with the electronic device to a remote apparatus which is associatable with the electronic device.

In a fourth aspect, there is provided a method of assembling a portable electronic device comprising assembling the apparatus with one or more (e.g. module) elements of a portable electronic device.

In a fifth aspect, there is provided a means for a portable electronic device, the means arranged to detect substantially simultaneous user input from device user interface elements arranged to detect opposing user input, and to provide signalling, upon the detection of said opposing user input, for transferring electronic information content associated with the electronic device to a remote apparatus which is associatable with the electronic device.

In a sixth aspect, there is provided an apparatus for a portable electronic device, the apparatus arranged to detect movement of the device, relative to a remote apparatus which is associatable with the electronic device, as user input from the device, and to provide signalling, upon the detection of said relative movement, for transferring electronic information content associated with the electronic device to the remote apparatus which is associatable with the electronic device.

The apparatus may be arranged to detect tipping of an end of the device over the remote apparatus as the user input.

The apparatus may be arranged to detect a simulated pouring of content from the device over the remote apparatus as the user input.

The apparatus may be arranged to detect passing of the device over the remote apparatus as the user input.

The apparatus may be arranged to detect wiping of the device over the remote apparatus as the user input.

The passing/wiping over may provide touching contact between the device and the remote apparatus. The passing/wiping over may provide non-touching proximal contact between the device and the remote apparatus. The proximal non-touching contact may provide a spacing, between the device and the remote apparatus, of the order of one or more of from the group comprising 30 cm or less, 25 cm or less, 20 cm or less, 15 cm or less, 10 cm or less, 5 cm or less cm. Alternatively the device and the remote apparatus may require touching contact.

The apparatus may be arranged to detect the user input following association of the device with the remote apparatus.

A combination of one or more of detected opposing user input (of the first aspect) and detected relative movement (of the second aspect) may provide the signalling for transferring electronic information content associated with the electronic device to a remote apparatus which is associatable with the electronic device.

The apparatus may be arranged to detect user input from user input elements arranged integrally with the apparatus. The apparatus may be arranged to detect user input from user input elements arranged integrally with the device. The apparatus may be arranged to detect user input from user input elements associated with the device (e.g. user input elements on a computer mouse).

The apparatus may comprise the information content stored on integrated memory. The information content may be stored on memory on a separate device/apparatus and the apparatus may be arranged to initiate the transfer of information content from the memory of the separate device/apparatus to the remote apparatus.

The apparatus may be arranged such that the transferring of electronic information content is provided to a remote apparatus which is connected to the device by a physical external connection (e.g. USB connection or A/V plug) which allows repeatable connection of the device and the remote apparatus.

The apparatus may be arranged such that the transferring of electronic information content is provided to a remote apparatus which is connected to the device by an air interface connection which allows repeatable connection of the device and the remote apparatus. The air interface may be a short-range air interface (e.g. RFID, Bluetooth™ interface with a PDA, earpiece, video screen, computer mouse, memory stick/card), medium range interface (e.g. interface with a cellular base-station) and/or long range interface (e.g. interface with a satellite).

The apparatus may be arranged such that the signalling for transferring electronic information content initiates a connection with the remote apparatus which allows the transfer of information content to the remote apparatus. The apparatus may be arranged such that the signalling for transferring electronic information content actually transfers information content to the remote apparatus.

The portable electronic device may be a computer mouse associated with a desktop/laptop computer. The portable electronic device may be a memory card/stick.

The apparatus may be arranged such that the electronic information content comprises one or more pre-recorded content selected from the group comprising electronic files for providing navigation content, audio (e.g. pre-recorded music files, voice messages) content, image (e.g. captured/scanned still picture/video picture) content, messaging (e.g. emailing, MMS, SMS) content, text content (e.g. word processing), and content files generated using software packages (e.g. pdf files, drawing package (e.g. Powerpoint™) content, word processing content, spreadsheet content).

The apparatus may be arranged such that the electronic information content comprises one or more live content, generated during the association of the remote apparatus with the device, selected from the group comprising providing navigation content, audio (e.g. music and/or speaking/voice) content, image (e.g. still picture/video picture) content, messaging (e.g. emailing, MMS, SMS) content, text content (e.g. word processing), and content files generated using software packages (e.g. pdf files, drawing package (e.g. Powerpoint™) content, word processing content, spreadsheet content).

The apparatus may be arranged such that the detection of relative movement input initiates/provides streaming of live content from the device to the remote apparatus.

The apparatus may comprise user input elements to detect the relative movement.

The apparatus may be a module for the portable electronic device.

In a seventh aspect, there is provided a portable electronic device comprising the aforementioned apparatus according to the sixth aspect.

In an eight aspect, there is provided a computer program for a portable electronic device, the computer program comprising computer code arranged to detect movement of the device, relative to a remote apparatus which is associatable with the electronic device, as user input from the device, and to provide signalling, upon the detection of said relative movement, for transferring electronic information content associated with the electronic device to the remote apparatus which is associatable with the electronic device

In a ninth aspect, there is provided a method of assembling portable electronic device comprising assembling the apparatus of the sixth aspect with one or more (e.g. module) elements of a portable electronic device.

In a tenth aspect, there is provided a means for a portable electronic device, the means arranged to detect movement of the device, relative to a remote apparatus which is associatable with the electronic device, as user input from the device, and to provide signalling, upon the detection of said relative movement, for transferring electronic information content associated with the electronic device to the remote apparatus which is associatable with the electronic device.

The present invention includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1 shows a first embodiment of a first aspect of the present invention;

FIG. 2 shows a first embodiment of a sixth aspect of the present invention; and

FIG. 3 shows a second embodiment of a sixth aspect of the present invention.

### DESCRIPTION OF SPECIFIC EMBODIMENTS

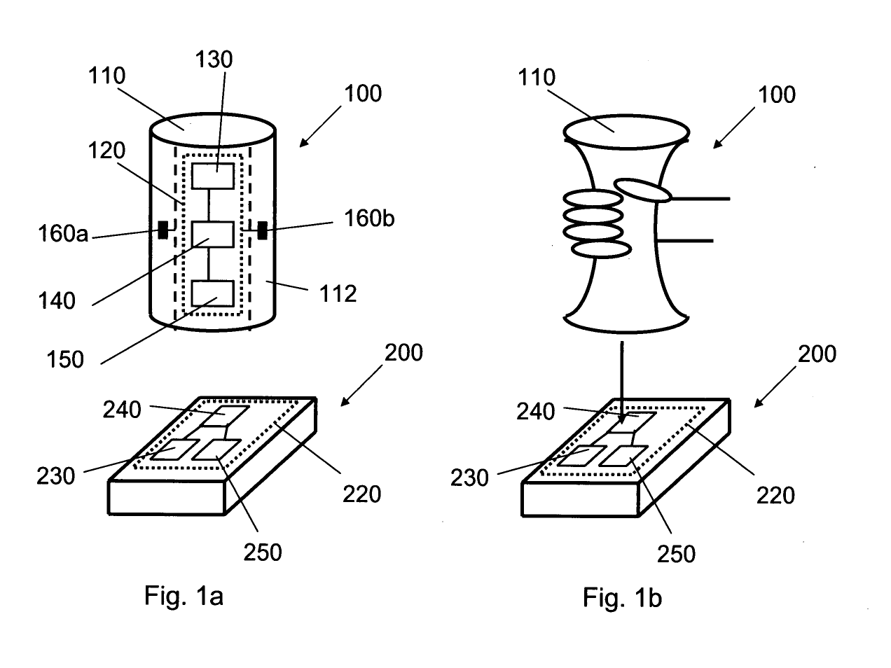

FIG. 1a shows a portable electronic device 100 and a remote apparatus 200 according to an embodiment of the present invention. The device 100 comprises a main body 110, which in the present embodiment is substantially cylindrical, and processing apparatus 120, said processing apparatus 120 including a memory 130, a processor 140 and a transmitter 150. In the present embodiment the memory 130 is arranged to store electronic data, including text and/or media files, such as music, video, etc., as well as any algorithms for use with the processing apparatus 120.

The device further comprises two user interface elements 160a, 160b, arranging in a substantially elastic outer region 112 of the main body 110. Each user interface element 160a, 160b is arranged such that they are disposed either side of a longitudinal axis of the main body, i.e. they are positioned on opposites sides of the main body 110.

Each user interface element 160a, 160b is arranged as an actuator, such as a strain gauge or pressure switch, or the like, and is arranged to detect deflection or compression of the outer region 112 of the main body 110. Each user interface element 160a, 160b is in communication with the processing apparatus 120.

The remote apparatus 200 also comprises a remote processing apparatus 210, which is similar to processing apparatus 120 of the device 100. The remote processing apparatus 210 comprises a remote memory 230, a remote processor 240 and a receiver 250. The remote memory 230 is arranged to store electronic data, including text and/or media files, such as music, video, etc. and the like, as well as any algorithms for use with the remote processing apparatus 220.

FIG. 1b shows the device 100 and remote apparatus 200 is use, in which a user may squeeze the deformable outer region 112 of the main body 110. The deformation of the outer region 112 is observed by the user interface elements 160a, 160b, and communicated to the processing apparatus 120.

When the processing apparatus 120 receives the communication from the user interface elements substantially simultaneously, i.e. to indicate that the main body 120 is being squeezed on both sides, the processor 140 is arranged to cause the transmitter 150 to transmit information relating the data stored on the memory 130. In the present embodiment the transmitter 150 is arranged to transmit the information by microwave RF, using a protocol such as Bluetooth™, Wibree™, or the like.

During such use, the remote apparatus 200 is arranged such that the receiver 200 receives the transmitted information from the device 100. The remote processor 240 is then arranged to cause this information to be stored on the remote memory 230. In effect, the device 100 and remote apparatus 200 are arranged such that when the device 100 is squeezed by a user, a predetermined transfer of data (e.g. based on prior user-selection), such as music and/or video data occurs, said predetermined transfer being a transfer of all of the data from the memory 130 to the remote memory 230, or of some of the data from the memory 130 to the remote memory 230.

While in the present embodiment both the transmitter 150 and receiver 250 are arranged to transmit and receive information respectively by relatively short range microwave RF, irrespective of the position of the device 100 relative to the remote apparatus 200, (e.g. transfer may occur if the device 100 and the remote apparatus are within 10 meters of one another, or the like, using Bluetooth™), in alternative embodiments this may not the case.

In alternative embodiment both the device 100 and the remote apparatus 200 may additionally comprise proximity sensors, such as unique identity proximity sensors, each arranged in communication with the processing apparatus 120 and the remote processing apparatus 220 respectively, and additionally arranged such that transfer can only occur when the device 100 is in non-touching proximal contact with the remote apparatus 220. Non-touching proximal contact may be a distance comprising 30 cm or less, 25 cm or less, 20 cm or less, 15 cm or less, 10 cm or less, 5 cm or less cm.

In alternative embodiments still, the device 100 may require ‘line of sight’ of the remote apparatus 200 before transfer occurs. Such an arrangement may be provided by a further ‘line of sight’ sensor on one or both of the device 100 and remote apparatus 200. Additionally or alternatively both the transmitter 150 and receiver 250 may be arranged to communicate by IrDA, or the like. A person skilled in the art will readily be able to implement such an arrangement.

Similarly while in the present embodiment the main body 110 is provided as a cylinder, it will be readily appreciated that alternative forms are possible, which might include substantially cubic/rectangular forms, substantially frustoconical forms, or the like. A skilled reader will readily appreciate that a cylinder is given by way of an example only. Similarly, while only two user interface elements 160a, 160b are shown here, in alternative embodiments any number of different number of user interface elements 160a, 160b may be provided, which may include 3, 4, 5, 10, 20, 100, or any number therebetween.

In addition, while in the present embodiment the user interface elements 160a, 160b are provided on substantially opposing sides of the main body 110, in alternative embodiments the user interface elements 160a, 160b may be provided at other regions of the main body 110, for example positioned at 30 degrees, 90 degrees, 120 degrees, etc to each other relative to the longitudinal axis. Rather than actuators in a deformable region, it will be readily appreciated that the user interface elements 160a, 160b may be actuators on a surface, such as switches on a surface i.e. substantial compression of a dimension of the device 100 per se may not be required.

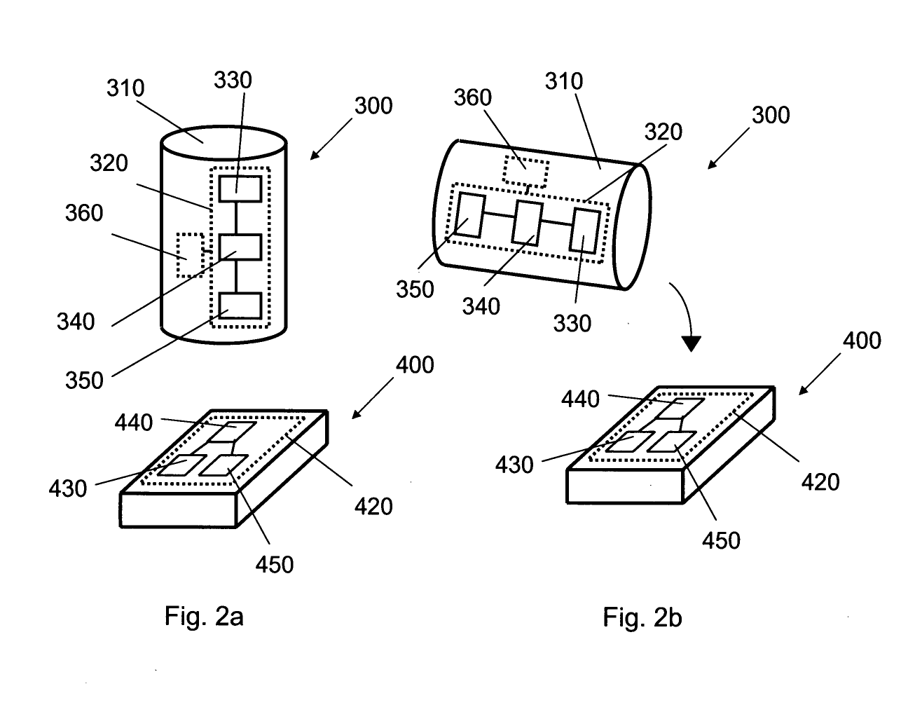

FIG. 2a shows a portable electronic device 300 and a remote apparatus 400 according to a further embodiment of the present invention. The device 300 comprises a main body 310, which in the present embodiment is substantially cylindrical, and processing apparatus 320, said processing apparatus 320 including a memory 330, a processor 340 and a transmitter 350. In the present embodiment the memory 330 is arranged to store electronic data, including text and/or media files, in a similar manner to that described above.

The device 300 further comprises a motion sensor 360. The motion 360 sensor is arranged to detect motion of the device 100 and is in communication with the processing apparatus 320. In the present embodiment the motion sensor 360 is provided by an angular motion MEMS (micro-electromechanical system), such as a gyro-MEMS, and thus is arranged to detect the angular movement of the device 300. Such angular movement may be considered as being relative to the remote apparatus 400, when, in use, the remote apparatus 400 is stationary.

In a similar manner to previous the embodiment the remote apparatus 400 also comprises a remote processing apparatus 410, comprising a remote memory 430, a remote processor 440 and a receiver 450. The remote memory 430 is arranged to store electronic data, including text and/or media files, such as music, video, etc. and the like, as well as any algorithms for use with the remote processing apparatus 420.

FIG. 2b shows the device 300 and remote apparatus 400 is use, in which a user may tilt the main body 310 of the device 300. Said tilting, or so-called tipping, is observed by the motion sensor 360, which communicates this to the processing apparatus 320. In the present embodiment, the motion sensor 360 is arranged to communicate to the processing apparatus when the device 300 has been tilted by more than 90 degrees from an upright, or stationary position. It will readily be appreciated that the motion sensor 360 may be arranged to communicate with the processing apparatus 320 when the device 300 has been titled through an alternative angle, such as 30, degrees, 60 degrees, 120 degrees, 180 degrees, or the like, or any angle therebetween.

When the processing apparatus 320 receives such a communication from the motion sensor, i.e. to indicate that the main body 120 is being tipped, the processor 340 is arranged to cause the transmitter 350 to transmit information relating to data stored on the memory 330. Again here information is transmitted by microwave RF, using a protocols such as Bluetooth™, Wibree™, or the like.

The remote apparatus 400 is arranged such that the receiver 450 receives the transmitted information from the device 300, and the processor 440 stores this information on the remote memory 430. In effect, the device 300 and remote apparatus 400 are arranged such that when the device 300 is tilted by a user, a predetermined transfer of data (e.g. prior user selected data), such as music and or video data, occurs in a similar manner to that described above.

Similarly, in alternative embodiments both the device 300 and the remote apparatus 400 may additionally comprise proximity sensors, such as unique identity proximity sensors, each arranged in communication with the processing apparatus 320 and the remote processing apparatus 420 respectively, and additionally arranged such that transfer can only occur when the device 300 is within a particular proximity to the remote apparatus 420.

Again, the device 300 may be provided by a further line of sight sensor on one or both of the device 300 and remote apparatus 400, or alternatively both the transmitter and receiver may be arranged to communicate by IrDA, or the like. A person skilled in the art will readily be able to implement such an arrangement.

Again, while the device 300 is detailed as a cylinder here, this is exemplary only. Similarly, while only one motion sensor 360 is shown, in alternative embodiments any number of motion sensors may be provided, which may include 3, 4, 5, 10, 20, 100, or any number therebetween.

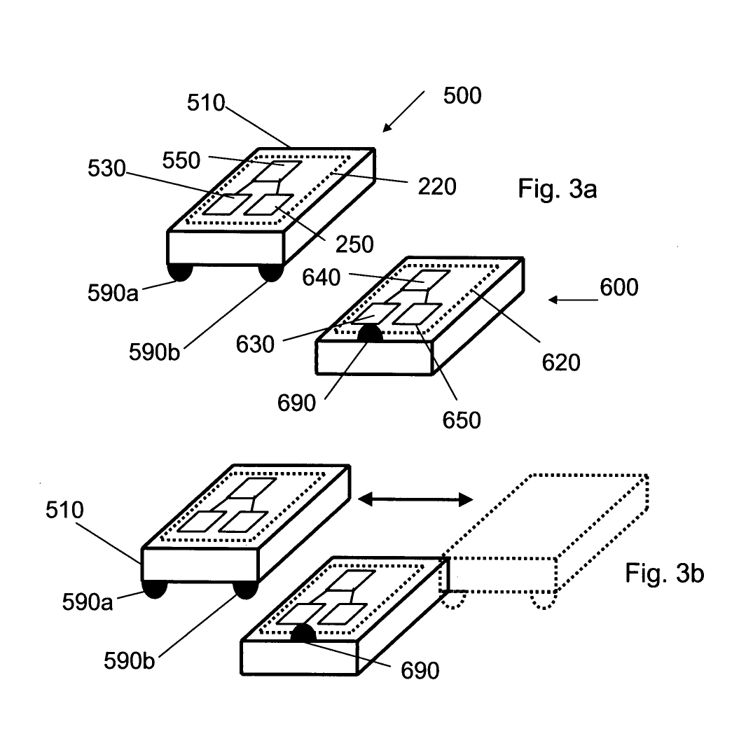

FIG. 3a shows a portable electronic device 500 and a remote apparatus 600 according to a further embodiment of the present invention. The device 500 comprises a main body 510 and processing apparatus 520, said processing apparatus 520 including a memory 530, a processor 540 and a transmitter 550, again the memory 530 being arranged to store electronic data, similar to that described above.

The device 500 comprises two collectors 590a, 590b arranged at a predetermined distance apart on the main body 510. Each collector 590a, 690b is in communication with the processing apparatus 520, and is arranged to receive a signatory IrDA communication from the remote apparatus 600, and communicate receipt thereof to the processing apparatus 520, as will be described herein.

In a similar manner to previous embodiments, the remote apparatus 600 also comprises a remote processing apparatus 610, comprising a remote memory 630, a remote processor 640 and a receiver 650. The remote memory 630 is arranged to store electronic data, including text and/or media files, such as music, video, etc. and the like, as well as any algorithms for use with the remote processing apparatus 620.

The remote apparatus further comprises an emitter 690, arranged to be in communication with the remote processing apparatus 520. In the present embodiment the emitter 690 is provided by a IrDA emitter, and is arranged to emit a signatory IrDA communication from remote apparatus 690, upon request by a user, such as by pressing an activation button or the like.

FIG. 3b shows the device 500 and remote apparatus 600 is use, in which a user may swipe/wipe the main body 510 of the device 500 over the remote apparatus 600, such that the two collectors 590 are substantially facing the emitter 690, when the emitter is emitting. In this arrangement, the first collector 590a receives the signatory IrDA communication from the remote apparatus 600, while the second collector 590b receives the signatory IrDA communication from the remote apparatus 600 sometime later.

In this arrangement the first collector 590a communicates such receipt of the signatory IrDA communication to the processing apparatus 520 at a first moment, and the second collector 590b communicates such receipt of the signatory IrDA communication to the processing apparatus 520 at a second moment, and the first and second moment being delayed from one another by a period of time.

When the processing apparatus 520 observes the communication from the collectors 590a, 590b, which are delayed by a period of time, this indicates that the device 500 is being swiped relative to the remote apparatus 600. This causes the processor 540 to cause the transmitter 550 to transmit information relating the data stored in the memory 530. The transmitter 550 is arranged to transmit the information by microwave RF, using a protocols such as Bluetooth™, Wibree™, or the like.

The remote apparatus 600 is arranged such that the receiver 650 receives the transmitted information from the device 500, and the processor 640 stores this information on the remote memory 630. In effect, the device 500 and remote apparatus 600 are arranged such that when the device 500 is swiped by a user over the remote apparatus 600, a predetermined transfer of data, such as music and or video data occurs similar to that described above.

In the present embodiment, the emitter/collectors are arranged to be able to communicate over a distance of 30 cm or less, which may be consider as non-touching contact proximity. Similarly, for the collectors 590 to receive the signatory IrDA communication, the collectors 590 are facing the emitter 690. It will readily be appreciated that this need not be the case. Similar arrangements, such as using RFID tags, or the like may be used to instigate data transfer when swiping the device 500 relative to the remote apparatus 600. A person skilled in the art would readily be able to implement such an arrangement.

Furthermore, the device 500 may be provided with only one collector 590a, 590b (or RFID tag, or the like), arranged such that the when the signatory communication is received, and then lost, this implies that the device 500 has been moved relative to the remote apparatus 600, which may be in a swiping motion, and thus data transfer occurs.

Similarly, there are further arrangements that would indicated that the device 500 has been moved relative to the remote apparatus 600, said movement being in a swiping motion, such as measuring the variation in induced voltage on a pick-up on one of the device 500 and remote apparatus 600, caused by the emission of magnetic field from an inductor on the other. A person skilled in the art will readily appreciate the many permutations, and appreciate that the above collector/emitter arrangement is given by way of an example only.

It will also be readily appreciated that in the above embodiments, the device 100, 300, 500 is arranged to transmit to the remote apparatus 200, 400, 600. In alternative embodiments, it may be the remote apparatus 200, 400, 600 that is arranged to transmit to the device 100, 300, 500 (the electronic information content then being that which is associated with the remote device). In further arrangements, data may be arranged to transfer either to or from the device 100, 300, 500 and the remote apparatus 200, 400, 600. In such an arrangement, a prior user input, made in a known manner, may predetermine from which one of the device 100, 300, 500 and remote apparatus 200, 400, 600 the data transfers. A person skilled in the art would readily be able to implement such further arrangements.

Similarly, while in the above embodiments transfer of data occurs wirelessly, it will readily be appreciated that a wired transfer may occur, such as my means of a USB connection or the like.

It will be appreciated that the detection of relative movement can be conducted by independently measuring movement of a device i.e. on the assumption that movement of the device per se implies relative movement with respect to a remote device.

It will be appreciated that the aforementioned device 100, 300, 500 and remote apparatus 200, 400, 600 may have other functions in addition to the mentioned functions, and that these functions may be performed by the same device 100, 300, 500 and remote apparatus 200, 400, 600. The aforementioned processing apparatus and functional elements of the device may be circuitry comprising one or more of hardware/firmware/software.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-62. (canceled)

63. An apparatus configured to:
detect user input from one or more of
substantially simultaneous user input from portable electronic device user interface elements, said portable electronic device user interface elements configured to detect opposing user input and
movement of a portable electronic device relative to a remote apparatus associated with the portable electronic device; and
provide signalling, upon the detection of said user input, for transferring predetermined electronic information content associated with the portable electronic device to the associated remote apparatus.

64. The apparatus according to claim 63, wherein the apparatus is configured to detect the opposing user input from user input elements configured to detect a squeeze, said squeeze providing an overall compression in one or more dimensions of the device.

65. The apparatus according to claim 63, wherein the apparatus is configured to detect substantially simultaneous user input from one or more of user input from the respective opposing device elements essentially provided by the user at the same time, and from one element shortly followed by user input from a second opposing element.

66. The apparatus according to claim 63, wherein the apparatus is configured to detect the opposing user input from user input elements configured to detect respective user inputs from at least one of physically towards one another, physically towards a central longitudinal axis of the electronic device, physically towards an inner point of the electronic device, and around a radial perimeter of the device.

67. The apparatus according to claim 63, wherein the apparatus is configured to detect the opposing user input from one or more of user input elements configured on two or more opposing faces of the device and user input elements arranged on two opposing faces of the device and a third device face which extends substantially orthogonal to the two opposing faces.

68. The apparatus according to claim 63, wherein the apparatus is configured to detect user input from one or more of user input elements configured integrally with the apparatus, user input elements configured integrally with the device and user input elements associated with the device.

69. The apparatus according to claim 63, wherein the apparatus comprises the information content stored on integrated memory.

70. The apparatus according to claim 63, wherein the information content is stored on a memory on a separate apparatus, and wherein the apparatus is configured to initiate the transfer of information content from the memory of the separate apparatus to the remote apparatus.

71. The apparatus according to claim 63, wherein the apparatus is configured such that the transferring of electronic information content is provided to a remote apparatus which is connected to the device by one or more of a physical external and air interface connection to allow repeatable connection of the device and the remote apparatus.

72. The apparatus according claim 63, wherein the apparatus is configured such that the signalling for transferring predetermined electronic information content initiates a connection with the remote apparatus which allows for transfer of the information content to the remote apparatus.

73. The apparatus according to claim 63, wherein the portable electronic device is one or more of a computer mouse which is configured to be associatable with one or more of a desktop and laptop computer, and a memory card and stick.

74. The apparatus according to claim 63, wherein the predetermined electronic information content comprises one or more pre-recorded content comprising at least one of electronic files for providing navigation content, audio content, image content, messaging content, text content, and content files generated using software packages.

75. The apparatus according to claim 63, wherein the predetermined electronic information content comprises one or more live content generated during the association of the remote apparatus with the device.

76. The apparatus according to claim 63, wherein the apparatus is configured to detect the user input following association of the device with the remote apparatus.

77. A computer program, the computer program comprising computer code configured to:
detect user input, the user input being detected from one or more of
substantially simultaneous user input from portable electronic device user interface elements, said portable electronic device user input elements configured to detect opposing user input, and
movement of a portable electronic device, relative to a remote apparatus which is associated with the portable electronic device; and
provide signalling, upon the detection of said user input, for transferring predetermined electronic information content associated with the portable electronic device to the associated remote apparatus.

78. The apparatus according to claim 63, wherein the apparatus is configured to detect user input movement of the portable electronic device using one or more of tipping of an end of the device over the remote apparatus, simulated pouring of content from the device over the remote apparatus, touching and non-touching passing of the device over the remote apparatus, and touching and non-touching wiping of the device over the remote apparatus.

79. The apparatus according to claim 63, wherein the apparatus comprises one or more user input elements to detect the one or more of a opposing and relative movement.

80. The apparatus according to claim 63, wherein the apparatus is a module for the portable electronic device or a portable electronic device.

81. Apparatus according to claim 63, wherein the apparatus is configured to transfer some or all of the predetermined electronic information content to the remote apparatus based on the detected user input.
